(19) United States
(12) Patent Application Publication
(10) Pub. No.: US 2026/0326475 A1
(43) Pub. Date: Oct. 22, 2026

(54) CARD-FORM DATA CARRIER HAVING LASER-ACTIVATABLE PIGMENTS, AND METHOD FOR PRODUCING SAME

(71) Applicant: GIESECKE+DEVRIENT EPAYMENTS GMBH, Munchen (DE)

(72) Inventors: Cristina FABIAN, Garching (DE); Josef RIEDL, Attenkirchen (DE); Klaus KOHL, Miesbach (DE); Peter TARANTINO, Munchen (DE); Thomas TARANTINO, Laufen (DE)

(21) Appl. No.: 19/106,787

(22) PCT Filed: Aug. 25, 2023
(86) PCT No.: PCT/DE2023/100618

§ 371 Date: Feb. 26, 2025

(30) Foreign Application Priority Data
Aug. 29, 2022 (DE) 10 2022 003 135.3

(51) Int. Cl. B42D 25/36; B42D 25/41

(52) U.S. Cl. CPC B42D 25/36; B42D 25/41

(57) ABSTRACT

A card-form data carrier has at least one film with a first surface and an opposite second surface. The film is produced by an extrusion process. Laser-activatable pigments are incorporated into at least parts of the film. The pigments are designed to be activatable by at least one laser, resulting in an irreversible color change in the film. A method is for producing a card-form data carrier.

The invention relates to a card-form data carrier with laser-activatable pigments and to a production method for a card-form data carrier of this kind.

A large number of card-form data carriers are known from the prior art, for example smart cards, chip cards, especially with RFID technology (radio-frequency identification), integrated circuit cards, dual-interface cards or identification cards. In particular, the use of smart cards, such as credit cards or debit cards, has become an established way of carrying out financial transactions. Card-form data carriers such as documents of value, for example passport and identity documents, identity cards and the like, are increasingly being used not just in public spheres but also in the company-internal sphere.

The card-form data carrier typically comprises a card body having a module opening to accommodate a chip module or other electronic components for contact-based and/or contactless data communication. The card body is often formed of a plurality of films, the individual films being bonded together by means of a lamination using pressure and heat to form a film layer composite. At the surface of the card body there are preferably design films or transparent cover films, known as overlay films, that have security features. Optical security features on the card-form data carriers are known and are intended generally to enhance anti-counterfeit security. It is also known practice to personalize data carriers using a laser, where the personalization can also serve as a security feature. In most cases, however, only black-color personalization is possible here. This limits the design possibilities and also the variability of security features.

It is an object of the present invention to provide a card-form data carrier, wherein personalization can be simplified and at the same time the security of the card-form data carrier can be improved.

This object is achieved by a card-form data carrier and, respectively, a method for producing a card-form data carrier of this kind as claimed in the independent claims. Configurations and developments of the invention are specified in the dependent claims. Features and details described in connection with the card-form data carrier of the invention also apply here in connection with the method of the invention, and vice versa in each case, so that mutual reference can always be made in respect of the disclosure in relation to the individual aspects of the invention.

Within the scope of the application, the invention can be used preferably for smart cards, in particular for credit cards and debit cards. However, it may also be preferable to envisage the use for security documents, such as identity documents, for example.

According to one aspect of the invention, a card-form data carrier is provided which comprises at least one film having a first surface and an opposite second surface, wherein the film is produced by means of an extrusion process, wherein at least partially laser-activatable pigments are integrated in the film, wherein the pigments are configured in such a way that they can be activated by means of at least one laser, whereby an irreversible color change of the film can be generated.

Within the scope of the application, laser-activatable pigments are provided which can be activated by means of a laser in order to generate an irreversible color change. In other words, therefore, pigments can be provided which are able to give rise to chromism, i.e., a change in color or a color change. Through the color change of the individual pigments, a color change of the film which comprises the individual pigments can be generated overall. Thermochromic pigments or photochromic pigments can preferably be used here. Thermochromic pigments are able to generate a change in color or a color change on heating, i.e., on an increase in temperature. In other words, the color change is induced by heat, in particular by the conversion of laser energy into heat energy. Photochromic pigments are able to induce a color change by light irradiation, in particular by light irradiation by means of laser light and its absorption. Generally, any pigments may be provided which can be activated by means of a laser in order to bring about a color change or a chromism. In general, a distinction can be made between reversible or irreversible chromism. In particular, the change in color is retained in the case of irreversible chromism and therefore persists durably.

In other words, the film may have an initial color due to the laser-activatable pigments in a first state, in particular in a non-heated state, and in a second state, in particular in a heated state, may have a different final color due to the change in color. The change in state from the initial color to the final color is described within the scope of the application with the color change or the change in color. As already mentioned, this change in state is provided irreversibly.

The invention has the advantage that color personalization of films of security documents, such as identity documents or smart cards, for example, can be enabled by means of the laser-activatable pigments. It is possible thereby to increase the anti-counterfeit security of the security document or the smart card, as color personalization constitutes an additional security feature. This security feature can be easily optically verified and can also be integrated easily into the security document or the smart card.

One possible embodiment, preferably, is that exactly one laser is provided for the activation of the laser-activatable pigments. It is therefore possible to dispense with the use of several lasers, for example four lasers for the colors red, green, blue and black. Thus the costs for laser personalization of the card-form data carrier can be reduced and the operation of producing the card-form data carrier can be simplified.

One possible embodiment, preferably, is that the laser is configured to be adaptable. One possible embodiment, in particular, is that a laser power of the laser is variably adjustable. This has the advantage that the adaptability of the laser allows the laser energy to be modulated precisely for the activation of the pigments for the color change. For example, the frequency timing of the laser and thus the laser power can be increased and thus a different color change can be achieved. Another possible embodiment, in particular, is that the laser power is adapted sectionally along the film in order thus to achieve multiple colors or color patterns. For example, the laser power may be modulated in a first region of the film for a color change to a blue final color and modulated in a second region of the film for a color change to a red final color. In particular, the laser power and thus also the laser energy can be variably modulated to the desired laser personalization of the card-form data carrier. Furthermore, it is therefore possible, advantageously, for complex colors and thus also complex patterns or shapes, such as a passport picture of the user of the card-form data carrier, for example, to be realized as a security feature.

One possible embodiment, more preferably, is that the laser is configured as an Nd:YAG laser or CO₂ laser or UV laser. The use of an Nd:YAG laser enables not only the described adaptability of the laser but also a very precise focusing of the laser energy or the laser beam. This means that even very complex patterns or shapes are candidates for the laser personalization. As a result, not only the design possibilities but also the anti-counterfeit security of the card-form data carrier can be increased. Generally, however, further adaptable lasers, such as the CO₂ laser or else fiber lasers or the like, are also conceivable.

One possible embodiment, preferably, is that the laser-activatable pigments are configured as metal pigments or metal oxide pigments. For example, molybdenum oxide compounds or titanium oxide compounds can be used. Similarly, metal salt compounds, such as iron, cobalt, nickel or molybdenum salts, can also be used as laser-activatable pigments. Generally, any materials that can be activated by a laser to generate a color change are conceivable for the pigments. The pigments are preferably integrated into the film by means of an extrusion process. This has the advantage in particular that the pigments are accommodated within the film in distributed and protected form and no separate printing ink has to be applied to the film.

One possible embodiment, alternatively or additionally, is that the film is configured to be substantially transparent. In particular, no complete transparency is envisaged here, owing to the laser-activatable pigments present within the film. In other words, the film has a substantially transparent initial color or, in other words, is configured to be initially colorless. Owing to the initial colorlessness, a maximum color impression for the final color can be achieved after activation of the laser-activatable pigments. In this way, for example, a color change from a substantially transparent initial color to a red final color can be achieved. Alternatively it is conceivable that the film is configured to be white or, in other words, has a white initial color. It is also conceivable that the film is configured to be colored or, in other words, has a colored initial color, such as, illustratively, red, green or blue. A colored initial color of the film has the advantage that the initial color together with the color change of the laser-activatable pigments can lead to a mixed final color and a desiredly altered overall color impression. Overall, through the selection of the initial color of the film, an optimization of the color impression of the card-form data carrier can be made possible. Any combinations of initial colors and final colors are conceivable here.

In one particularly preferred embodiment, it may be the case that the color change of the film is visible in the optical range. This has the advantage that a security feature can be generated which can be verified particularly easily, for example by a user of the card-form data carrier.

One possible embodiment, advantageously, is that the laser-activatable pigments can be activated at a temperature greater than an extrusion temperature of the film, preferably 300 °C. In particular, this has the advantage that the color change of the film does not take place in an uncontrolled manner during extrusion, but can instead take place in a controlled manner on the fully formed film after extrusion. In other words, an optimal temperature range can be selected in which the laser-activatable pigments can be activated without adversely affecting the film or the films of the card-form data carrier.

A further possible embodiment, preferably, is that for the generation of a multicolor image on the first surface of the film, the color change of the film is controllable by means of the laser. In this case, for example, a single-color color change can be provided for a single-color personalization or a multicolor color change for a multicolor personalization. As already described, the laser power can be controlled sectionally along the film in order thus to achieve multiple colors or color patterns of the film.

One possible embodiment, preferably, is that the card-form data carrier has at least one transparent overlay film, which is arranged on the first surface of the film in such a way that the color change of the film is visible. The color change of the film may preferably represent a security feature of the card-form data carrier. The overlay film allows the longevity of the security feature achieved to be guaranteed. At the same time, the transparency of the overlay film makes it easy to identify and verify the security feature.

One possible embodiment, preferably, is that the laser-activatable pigments have a pigment size of at least 1 μm and at most 60 μm.

One possible embodiment, more preferably, is that the laser-activatable pigments are distributed homogeneously in the film or are distributed along at least one edge of the film. By means of a homogeneous distribution, a uniform color change can advantageously be achieved. In the case of distribution along the edges of the film, in particular, edge personalization of the film or the card-form data carrier can be achieved.

One possible embodiment, furthermore preferably, is that the color change is generated along at least one edge of the film. In particular, the color change can be generated along all edges of the film. A specific color impression can therefore be achieved comprehensively along the edges of the film. For example, multicolor edges or else multicolor logos can be generated along the edges of the film. In particular, edge personalization of the card-form data carrier may further increase the anti-counterfeit security. As a result, advantageously, the use of colored core films can be dispensed with. This improves warehousing and logistics in particular.

One possible embodiment, preferably, is that the card-form data carrier has at least one light-diffracting or light-refracting structure, in particular wherein at least one laser beam of the laser for the activation of the laser-activatable pigments can be passed through the light-diffracting or light-refracting structure. Generally, a plurality of such structures can be provided for the card-form data carrier. The light-diffracting or light-refracting structure can be referred to as a lens structure within the scope of the application. One embodiment, preferably, is that the lens structure is arranged on a surface of the card-form data carrier, in particular on an exterior film of the card-form data carrier. The lens structure may preferably be arranged on a first surface and on an opposite second surface of the card-form data carrier. Generally, the lens structure may comprise a surface relief in the form of a lens array. In this case, individual lenses may be configured, for example, as recesses and/or elevations on the surface of the card-form data carrier. By means of a lens array with a number or multiplicity of individual lenses such as ball lenses, rod lenses and/or cylindrical lenses, for example, various optically variable effects can be achieved in interaction with the color change of the laser-activatable pigments. Hence an optical security feature can be generated which further increases the anti-counterfeit security of the card-form data carrier.

One possible embodiment, in particular, is that at least one laser beam of the laser for the activation of the laser-activatable pigments can be passed through the light-diffracting or light-refracting structure. In other words, the laser beam can be passed or guided through the lens structure onto the laser-activatable pigments. Because of the lens structure, the laser beam can experience a specific deflection or directional variation, whereby further optical effects can be achieved in interaction with the laser-activatable pigments.

One possible embodiment is that the light-diffracting or light-refracting structure or the lens structure during lamination is arranged or inserted by means of at least one laminating plate on the card-form data carrier, in particular on a surface of the card-form data carrier, such as on a surface of an overlay film of the card-form data carrier, for example. The film with the integrated laser-activatable pigments can be produced, considered temporally, before the lamination. In particular, the lens structure to be formed on the card-form data carrier can be introduced as a laminating structure into the laminating plate by a negative image. For example, if the lens structure is to be introduced on the first surface and the opposite second surface of the card-form data carrier, two laminating plates each with a corresponding laminating structure can be used. During laminating, the card-form data carrier is arranged illustratively between the laminating plates. By means of the laminating plates, pressure can be exerted on the card-form data carrier, and a temperature increase is usually also performed during lamination.

Via the prevailing pressure and the heat, the corresponding lens structure can be laminated in by means of the respective laminating structure on the respective surface of the card-form data carrier. This simplifies the fabrication of the card-form data carrier because the lens structure can be produced even during lamination rather than in a separate fabrication step.

As an alternative to the laminating plate, one or more stamps may be provided for introducing the lens structure onto the card-form data carrier. Generally, for example, a laminating plate, an embossing stamp, a gravure plate and/or an ultrasonic process can be used for introducing the lens structure.

According to a second aspect of the invention, a method for producing a card-form data carrier is provided, in particular according to any of the preceding embodiments, wherein the method comprises the following steps:
providing at least one film material;
providing laser-activatable pigments;
introducing the film material and the laser-activatable pigments as a mixture into an extruder of an extrusion device,
heating the mixture to form a melt;
extruding the melt through a die exit gap of the extrusion device to form a film having a first surface and an opposite second surface, wherein the laser-activatable pigments are integrated at least partially in the film;
activating the laser-activatable pigments by means of at least one laser to generate an irreversible color change of the film.

The sequence of the steps of the method of the invention is not necessarily restricted to the described sequence or fixed in time. In particular, the film material and the pigments can be provided sequentially or simultaneously. Moreover, lamination with further films can take place before activation of the laser-activatable pigments.

Within the scope of the application, it is possible for example for the film material to be provided in the form of pellets for the extruder, more particularly in the form of plastics pellets. In the extruder, the mixture of the film material and the laser-activatable pigments can be heated to form a melt, or melted. In other words, the mixture is converted into a molten state. In particular, the melt comprises the molten film material and the laser-activatable pigments. The melt can then be extruded/forced out through the nozzle outlet gap. The nozzle outlet gap here constitutes a shaping opening. By the extrusion of the melt through the die exit gap, a film can be formed, where in particular the laser-activatable pigments are integrated in the film or are arranged within the film. The extruded melt can usually cool down or solidify completely to form the film at a certain time interval after exit from the die exit gap. By solidification of the film, the film can form a kind of solid matrix around the laser-activatable pigments, so that they are durably integrated within the film. For cooling, the extruded melt can be conveyed, for example, on a roll arrangement adjacent to the die exit gap and comprising at least one chill roll. The laser-activatable pigments can be activated by means of the laser, considered temporally, after the formation of the film, in particular after the final solidification of the film. The activation generates the irreversible color change of the individual pigments and thus also of the film.

The same advantages and modifications as described above continue to apply. In particular, the anti-counterfeit security of the card-form data carrier can be increased because of the color personalization according to the invention.

One possible embodiment, preferably, is that a lamination of the film with at least one transparent overlay film and/or further films takes place, considered temporally, before the activation of the laser-activatable pigments. In particular, the overlay film can be arranged on the first surface of the film. Preferably, a plurality of further films can be provided for the card-form data carrier, and in that case can be arranged in particular on the second surface of the film. The further films may be configured, for example, as core films and preferably be configured to be opaque. Advantageously, the card-form data carrier is laminated with all present films as a film layer structure and thereafter the laser-activatable pigments are activated by means of the laser. In other words, the color personalization according to the invention takes place preferably after lamination of the films of the card-form data carrier.

In summary, the film with the laser-activatable pigments can be produced, considered temporally, first by means of the extrusion process described. Lamination as a film layer structure may then take place preferably with further films. The color personalization can then take place by activation of the laser-activatable pigments.

One possible embodiment, more preferably, is that at least one light-diffracting or light-refracting structure is arranged on the card-form data carrier, in particular wherein at least one laser beam of the laser for the activation of the laser-activatable pigments is passed through the light-diffracting or light-refracting structure. In other words, a preferred embodiment is that the activation of the laser-activatable pigments by means of the laser takes place, considered temporally, after the arrangement of the light-diffracting or light-refracting structure on the card-form data carrier. Expressed alternatively, the laser beam of the laser for the activation of the pigments can be passed through the lens structure onto the pigments. Advantageously, further optical effects can be generated by these means.

The present invention is described below with reference to the accompanying figures by way of example in the context of embodiments. It goes without saying that individual features of the embodiments, if technically feasible, can be freely combined with one another without departing from the scope of the present invention. Elements having the same function and mode of operation are provided with the same reference signs in the figures. In the figures schematically below:

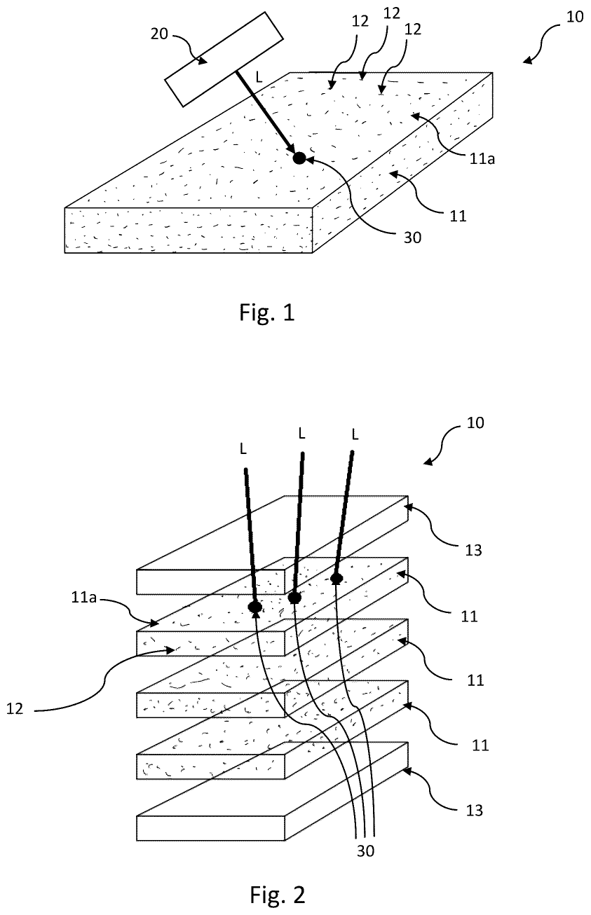

FIG. 1: shows a card-form data carrier in one exemplary embodiment according to the invention;

FIG. 2: shows a card-form data carrier in another exemplary embodiment according to the invention;

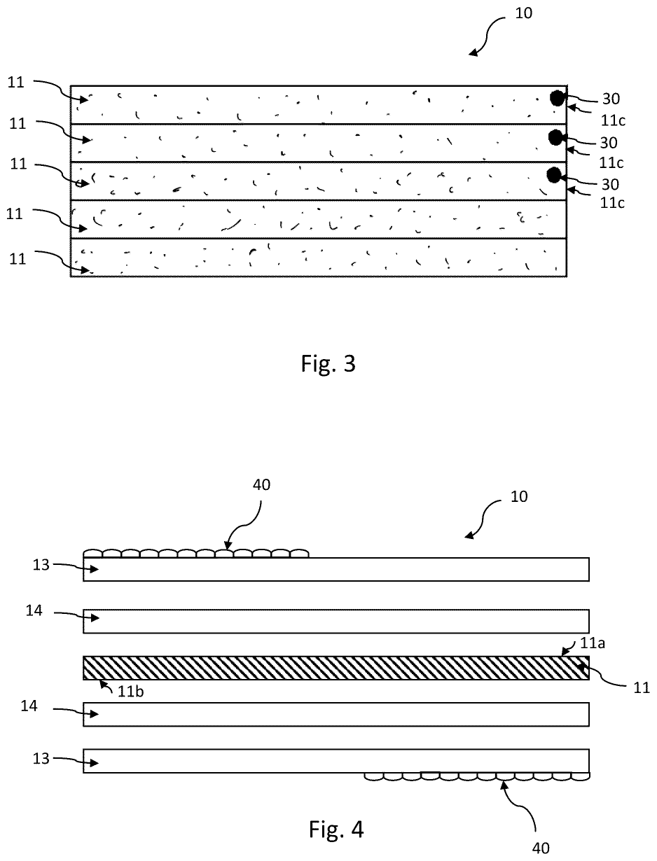

FIG. 3: shows a card-form data carrier in a third exemplary embodiment according to the invention; and

FIG. 4: shows a card-form data carrier in a fourth exemplary embodiment according to the invention.

FIG. 1 shows a card-form data carrier 10 in a first exemplary embodiment according to the invention. For example, the card-form data carrier 10 may be configured as an identity document or as a smart card. The card-form data carrier 10 comprises a film 11 having a first surface 11a and an opposite second surface (not visible). For example, a chip module and/or further electronic components for contact-based and/or contactless data transmission may be provided on the film 11, in a module opening not represented. For the sake of clarity, the electronic components of the card-form data carrier 10, such as the chip module, for example, are not represented in FIGS. 1 to 4.

The film 11 is configured illustratively to be substantially transparent. In particular, laser-activatable pigments 12 are integrated in the film 11, which are represented illustratively by means of the dots in the film 11. Owing to the laser-activatable pigments 12 present in the film 11, no complete transparency of the film 11 is provided.

The laser-activatable pigments 12 are illustratively distributed homogeneously in the film 11. Furthermore, the pigments 12 are configured in such a way that they can be activated by means of a laser 20, whereby an irreversible color change 30 of the film 11 can be generated.

Illustratively, exactly one laser 20 is provided for the activation of the laser-activatable pigments 12. In particular, the laser 20 is configured to be adaptable. Preferably, a laser power of the laser 20 can be variably adjusted. For example, the laser 20 is configured to be an Nd:YAG laser.

For example, the laser-activatable pigments 12 may have a pigment size of at least 1 μm and at most 60 μm and/or be configured to be metal pigments.

For the activation of the laser-activatable pigments 12, a laser beam L may impinge on the respective pigments 12 by means of the laser 20. The laser beam L is represented illustratively by means of the arrow. By the impingement of laser energy of the laser 20 or the laser beam L on the laser-activatable pigments 12 in the film 11, the laser energy can be converted, for example, into thermal energy. By the conversion into thermal energy, the temperature of the pigments 12 can be increased. By virtue of the temperature increase, the pigments 12 can bring about a color change 30. The color change 30 is represented illustratively as a black circle 30. However, this can be a color change 30 to a red, green, or blue final color. In other words, due to the incident laser beam L on a region of the film 11, a change in color of the laser-activatable pigments 12 in this region and thus a change in color of the film 11 in this region is achieved. For the sake of clarity, only a single color change 30 is shown illustratively here. However, a plurality of color changes to various final colors can be provided at different points of the film 11 as desired. Alternatively, the activation of the laser-activatable pigments 12 may take place photochromically, as already described.

As already described, the color change 30 can be generated sectionally in the film 11, wherein the laser beam L of the laser 20 is focused only onto a partial region of the film 11. The circle represented shows illustratively the partial area of the film 11 for the color change 30. Alternatively, the color change 30 can be generated in the entire film 11, wherein the laser beam L of the laser 20 is moved along the film 11 or is focused onto the entire film 11. Preferably, therefore, the edges of the film 11 can also be personalized.

One possible embodiment, in particular, is also that the laser power is adapted sectionally along the film 11 in order thus to achieve multiple colors or color patterns. For example, the laser power may be modulated in a first region of the film 11 for a color change 30 to a blue final color and modulated in a second, different region of the film 11 for a color change to a red final color. The laser power and thus also the laser energy can thus be variably modulated to the desired laser personalization of the card-form data carrier 10.

The color change 30 of the film 11 is preferably visible in the optical range, thereby enabling simple verification by a user of the card-form data carrier 10.

Advantageously, by means of the laser-activatable pigments 12 which are integrated in the film 11, color personalization of the card-form data carrier 10 can be made possible. Thus the anti-counterfeit security of the card-form data carrier 10 can be increased.

The film 11 is produced in particular by means of an extrusion process. For this purpose, for example, the film material can be provided as pellets for an extruder of an extrusion device not represented, in particular as plastics pellets. Furthermore, the laser-activatable pigments 12 can be provided for the extruder. The pigments 12 and the film material can be introduced into the extruder as a mixture. In the extruder, the mixture of the film material and the laser-activatable pigments 12 can be heated to form a melt, or melted. The melt can then be extruded or pressed out through a die exit gap of the extrusion device. By the extrusion of the melt through the die exit gap, the film 11 can be formed, where in particular the laser-activatable pigments 12 are integrated in the film 11 or are arranged within the film 11. As described, the laser-activatable pigments 12 can be activated by means of the laser 20, considered temporally, after the formation of the film 11, in particular after the final solidification of the film 11. The activation generates the irreversible color change 30 of the individual pigments 12 and thus also of the film 11.

FIG. 2 shows a card-form data carrier 10 in a further exemplary embodiment according to the invention. The card-form data carrier 10 comprises, for example, three films 11 configured in analogy to FIG. 1, each with laser-activatable pigments 12.

In contrast to FIG. 1, in FIG. 2, three color changes 30 on the basis of three laser beams L are represented illustratively by means of the black circles. The color changes 30 are provided illustratively for the final colors red, green and blue. The color changes 30 can each occur at different temperatures for the different colors. Consequently, the laser power for the respective laser beam L can be variably modulated to achieve the desired color change 30.

Furthermore, the card-form data carrier 10 comprises further films in addition to the three films 11 with the laser-activatable pigments 12. In other words, for the card-form data carrier 10, a film layer structure, composed in particular of films arranged atop one another or stacked, is provided. In particular, two exteriorly arranged transparent overlay films 13 are provided. In other words, the films 11 with the laser-activatable pigments 12 are arranged between the exterior overlay films 13. By means of the overlay films 13, the laser-activatable pigments 12 in the films 11 can be additionally protected. The number and the material of the films of the film layer structure can be modulated as required. Essentially, the number or the arrangement of transparent or opaque core films and/or transparent overlay films 13 can generally be varied.

A further embodiment for a different arrangement of the films in the film layer structure for the card-form data carrier 10 is shown in FIG. 3. The card-form data carrier 10 comprises, for example, five films 11 configured in analogy to FIG. 1, each with laser-activatable pigments 12. Illustratively, three color changes 30 are shown, these being generated along the edges 11c of the respective films 11. The color change 30 can preferably be generated along all edges 11c of the films 11. A specific color impression can therefore be achieved comprehensively along the edges 11c of the film 11. Edge personalization of the card-form data carrier 10 can further increase the anti-counterfeit security in particular. As a result, advantageously, the use of colored core films can be dispensed with.

FIG. 4 shows a further embodiment for a card-form data carrier 10. The card-form data carrier 10 has, illustratively, a film layer structure. A film 11 according to the invention is arranged centrally in the film layer structure. The film 11 has a first surface 11a and an opposite second surface 11b. Laser-activatable pigments 12, not represented, are integrated in the film 11. The film 11 is configured analogously to FIG. 1.

The laser-activatable pigments 12 are configured in such a way that they can be activated by means of a laser, whereby an irreversible color change 30 of the film 11 can be generated. The laser-activatable pigments 12 can be activated in line with the description for FIG. 1. The film 11 is arranged between two transparent core films 14. A transparent overlay film 13 is arranged in each case on the transparent core film 14.

The transparent overlay films 13 each have a lens structure 40 on an exterior surface. The lens structure 40 generally represents a light-diffracting or light-refracting structure. It may be provided that the lens structure 40 extends only partially or completely along the surface of the overlay film 13. In particular, it is provided that the lens structure 40 is arranged overlappingly or with partial covering in relation to the laser-activatable pigments 12 of the film 11. As a result of this, it is possible advantageously to pass a laser beam L of the laser 20 for the activation of the laser-activatable pigments 12 through the lens structure 40 onto the laser-activatable pigments 12.

The lens structure 40 may be a surface relief in the form of a lens array.

Illustratively, a lens array with individual lenses such as ball lenses, rod lenses and/or cylindrical lenses can be used.

Through the interaction between the laser-activatable pigments 12 and the lens structure 40, an observer can recognize viewing angle-dependent representations or flip images or, generally, optically variable effects. This generally increases the anti-counterfeit security of the card-form data carrier 10 and represents a further security feature.

### LIST OF REFERENCE SIGNS

10 card-form data carrier
11 film
11a first surface
11b second surface
11c edge
12 laser-activatable pigments
13 overlay film
14 core film
20 laser
L laser beam
30 color change
40 lens structure

1.-17. (canceled)

18. A card-form data carrier which comprises at least one film having a first surface and an opposite second surface,
wherein the film is produced by an extrusion process,
wherein at least partially laser-activatable pigments are integrated in the film,
wherein the pigments are configured in such a way that they can be activated by at least one laser,
wherein an irreversible color change of the film can be generated.

19. The card-form data carrier according to claim 18, wherein exactly one laser is provided for the activation of the laser-activatable pigments.

20. The card-form data carrier according to claim 18, wherein the laser is configured to be adaptable.

21. The card-form data carrier according to claim 20, wherein a laser power of the laser is variably adjustable.

22. The card-form data carrier according to claim 18, wherein the laser is configured as an Nd:YAG laser or CO2 laser or UV laser.

23. The card-form data carrier according to claim 18, wherein the laser-activatable pigments are configured as metal pigments or metal oxide pigments.

24. The card-form data carrier according to claim 18, wherein the color change of the film is visible in the optical range.

25. The card-form data carrier according to claim 18, wherein the laser-activatable pigments can be activated at a temperature greater than an extrusion temperature of the film.

26. The card-form data carrier according to claim 18, wherein for the generation of a multicolor image on the first surface of the film, the color change of the film is controlled by the laser.

27. The card-form data carrier according to claim 18, wherein the card-form data carrier has at least one transparent overlay film, which is arranged on the first surface of the film in such a way that the color change of the film is visible.

28. The card-form data carrier according to claim 18, wherein the laser-activatable pigments have a pigment size of at least 1 μm and at most 60 μm.

29. The card-form data carrier according to claim 18, wherein the laser-activatable pigments are distributed homogeneously in the film or are distributed along at least one edge of the film.

30. The card-form data carrier according to claim 18, wherein the color change is generated along at least one edge of the film.

31. The card-form data carrier according to claim 18, wherein the card-form data carrier has at least one light-diffracting or light-refracting structure, in particular wherein at least one laser beam of the laser for the activation of the laser-activatable pigments can be passed through the light-diffracting or light-refracting structure.

32. A method for producing a card-form data carrier, in particular according to claim 18, wherein the method comprises the following steps:
providing at least one film material;
providing laser-activatable pigments;
introducing the film material and the laser-activatable pigments as a mixture into an extruder of an extrusion device,
heating the mixture to form a melt;
extruding the melt through a die exit gap of the extrusion device to form a film having a first surface and an opposite second surface, wherein the laser-activatable pigments are integrated at least partially in the film;
activating the laser-activatable pigments by at least one laser to generate an irreversible color change of the film.

33. The method according to claim 32, wherein a lamination of the film with at least one transparent overlay film and/or further films takes place, considered temporally, before the activation of the laser-activatable pigments.

34. The method according to claim 32, wherein at least one light-diffracting or light-refracting structure is arranged on the card-form data carrier, in particular wherein at least one laser beam of the laser for the activation of the laser-activatable pigments is passed through the light-diffracting or light-refracting structure.
